(19) United States
(12) Patent Application Publication
(10) Pub. No.: US 2013/0063621 A1
(43) Pub. Date: Mar. 14, 2013

(54) IMAGING DEVICE

(71) Applicant: Yoichi ITO, Tokyo (JP)

(72) Inventor: Yoichi ITO, Tokyo (JP)

(21) Appl. No.: 13/606,503

(22) Filed: Sep. 7, 2012

(30) Foreign Application Priority Data
Sep. 9, 2011 (JP) 2011-197149

(51) Int. Cl. H04N 5/225

(52) U.S. Cl. 348/222.1; 348/E05.024

(57) ABSTRACT

An imaging device includes an imaging section configured to receive a light beam from a subject, and output an image signal, an image processor configured to produce image data based on the image signals input from the imaging section, a recording section configured to record the image data from the image processor as moving image data, an operation section configured to designate start and stop of recording of the moving image data, an attention point moving image designation section configured to designate an attention point moving image as a set of moving images which are stored by being clipped from a moving image, an attention point moving image time designation section configured to designate a clipping time of the attention point moving image, and a controller configured to control the recording section such that the attention point moving image for the clipping time is recorded in the recording section.

### PRIORITY CLAIM

The present application is based on and claims priority from Japanese Patent Application No. 2011-197149, filed on Sep. 9, 2011, the disclosure of which is hereby incorporated by reference in its entirety.

### BACKGROUND

1. Field of the Invention

The present invention relates to an improvement in a moving image photographable imaging device.

2. Description of the Related Art

Unlike photographing of a picture in which a fixed photographing object is captured at one moment to be recorded, photographing of a moving image with a digital video camera, digital camera or the like requires a photographing technique such as planning of a story, camerawork, or the like in order to obtain a good story-like video picture. For this reason, not everyone can necessarily perform photographing in order to easily obtain a good video picture.

On of the main reasons that a good video picture can not be obtained is because a long real-time video picture is often shown as it is.

Such a long video picture usually only becomes a good story-like video picture after an editing process which connects short scenes.

However, most users do not edit such video pictures because of the complicated editing processes involved, and usually only store the video picture in a recording medium such as a tape or hard disk without reviewing the video picture. Even if the user reviews the vide picture, it may not be a particularly favorable video picture except for the person who has photographed it and the people familiar with it.

Various measures are proposed related to the above problem. For example, the following measure does not use an editing process and is proposed from the viewpoint of easily reflecting a user's photographing intention.

For example, a known video camera has a plurality of themes such as a trip or sport in the case of scenario mode photographing.

Such a video camera uses a technique which guides a recommended photographing scene suitable for each theme. With this constitution, a user can obtain a good video picture by selecting a recommended photographing time (second) in each scene, for example, 4 seconds or 8 seconds.

For the purpose of photographing a high-quality finished moving image having a good story, a technique which inputs scenario data including a photographing method and a title before photographing and performs a photographing guidance in accordance with the scenario data is proposed.

Moreover, for the purpose of providing a technique which can easily clip a moving image for a predetermined time, a technique which clips a moving image just like the photographing of a moving image (refer to Japanese Patent Application Publication Nos 2006-174318 and 2011-010215, for example) is proposed.

The measure related to the scenario mode photographing is very effective under a condition in which the user can previously figure out a scenario or a position of a subject such as at a wedding party, and has a time for selecting a scenario such as slow party.

However, with the measure related to the scenario mode photographing, a photographing chance may be missed while selecting a scenario under a condition which can not previously figure out a position of a subject such as at a children's sport festival or does not have a time for selecting a scenario such as a fast progress of a sport festival.

For this reason, a user will often perform real-time photographing in order to avoid missing a photographing chance. As a result, a long video picture of not necessarily very good quality is photographed. Therefore, an editing process is required in the playback of the video picture.

### SUMMARY

The present invention has been made in view of the above circumstances, and an object of the present invention is to provide an imaging device which can easily obtain a good video picture in which a user's photographing intention is reflected without missing a photographing chance.

In order to achieve the above object, one embodiment of the present invention provides an imaging device, including an imaging section configured to receive a light beam from a subject, and output an image signal by photoelectrically converting the received light beam; an image processor configured to produce image data based on the image signals input from the imaging section; a recording section configured to record the image data from the image processor as moving image data during photographing in a moving image mode; an operation section configured to designate start and stop of recording of the moving image data to the recording section; an attention point moving image designation section configured to designate an attention point moving image as a set of moving images which are stored by being clipped from a moving image obtained by moving image photographing during the photographing in the moving image mode; an attention point moving image time designation section configured to designate a clipping time of the attention point moving image; and a controller configured to control the recording section such that the attention point moving image for the clipping time designated by the attention point moving image time designation section is recorded in the recording section at every designation of the attention point moving image designation section during the photographing in the moving image mode by the operation of the operation section.

### BRIEF DESCRIPTION OF THE DRAWINGS

The accompanying drawings are included to provide further understanding of the invention, and are incorporated in and constitute a part of this specification. The drawings illustrate an embodiment of the invention and, together with the specification, serve to explain the principle of the invention.

FIG. 1 is top view of a digital camera as an imaging device according to an embodiment of the present invention.

FIG. 2 is a front view of the digital camera illustrated in FIG. 1.

FIG. 3 is a back view of the digital camera illustrated in FIG. 1.

FIG. 4 is a block diagram illustrating a circuit constitution of a control system of the digital camera illustrated in FIG. 1.

FIG. 5 is a schematic view illustrating a relationship between a real-time moving image and a moving image for clipping in a moving image mode.

FIG. 6 is a view illustrating one example of an attention point moving image designation section in a video camera.

FIGS. 7A, 7B, 7C are views each illustrating one example of an attention point moving image designation section in a digital camera having a touch-screen liquid crystal display device.

FIGS. 8A, 8B, 8C are views each illustrating a menu screen for describing a procedure for setting a snap moving image.

FIG. 9 is a schematic view describing the meaning of “CENTER FOCUS”, “BEGINNING”, “LAST” and “CUSTOM” on a snap moving image clipping setting screen.

FIG. 10 is a schematic view describing the general description of snap moving image photographing.

FIG. 11 is a view illustrating a constitution of a moving image file of MPEG method.

FIG. 12 is a view illustrating a recording constitution to a recording medium of FAT (File Allocation Table).

### DESCRIPTION OF THE PREFERRED EMBODIMENT

### Embodiment

Hereinafter, an embodiment of a digital camera as an imaging device according to the present invention will be described with reference to the accompanying drawings.

### (General Constitution of Digital Camera)

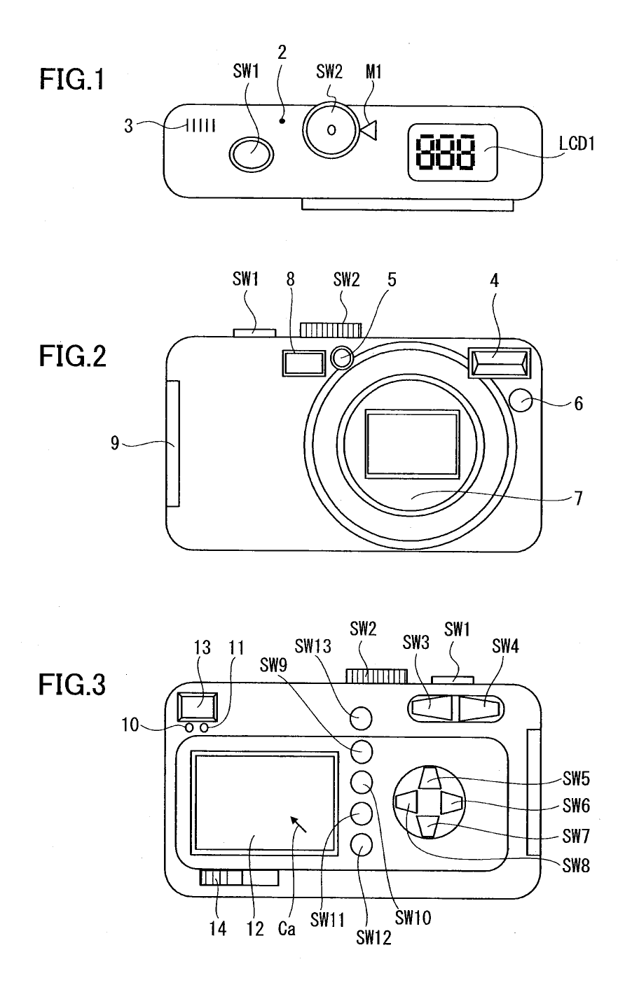

FIG. 1 is a top view of a digital camera according to the embodiment. FIG. 2 is front view of the digital camera illustrated in FIG. 1. FIG. 3 is a back view of the digital camera illustrated in FIG. 1.

Referring to FIG. 1, the top surface of the digital camera includes a sub LCD1, shutter button SW1, mode dial SW2, microphone 2 and speaker 3. The sub LCD 1 displays the number of photographable still images or the like. The shutter button SW1 is pressed when photographing a still image or a moving image, and is used as an operation section for designating the start and stop of the recording of moving image data to the after-described recording section in a moving image mode. The mode dial SW2, microphone 2 and speaker 3 will be described later.

The shutter button SW1 is a two-step switch. This shutter button SW1 includes a half-pressing operation and full-pressing operation. The digital camera operates AE (auto exposure) and AF (auto focusing) by the half-pressing operation of the shutter button SW1. By the full-pressing operation of the shutter button SW1, AWB (auto white balance) is operated, and a still image is photographed.

The mode dial SW2 is a dial type switch. The top surface of the digital camera includes an indication mark M1 next to the mode dial SW2. By moving the mode of the mode dial SW2 to the position of the indication mark M1, the operation mode of the digital camera is set.

The operation mode of the digital camera includes a still image-photographing mode which photographs a still image, a scene-photographing mode, a moving image-photographing mode which photographs a moving image, a playback mode which plays a photographed image, and a setup mode which sets a camera mode.

The scene-photographing mode is further classified. This scene-photographing mode includes a subject-tracking mode, portrait mode, face mode, sport mode, distant view mode, night view mode, high sensitive mode, zoom macro mode, black and white mode, sepia mode, inclination correction mode, character mode and the like. The switching of these modes is performed by the operation of the mode dial SW2.

The front surface of this digital camera includes a flash light-emitting section 4, AF auxiliary light/self-timer lamp 5, remote control light-receiving section 6, lens barrel unit 7 and front optical finder 8 as illustrated in FIG. 2. The side surface of the digital camera includes a memory card socket and battery housing. The memory card socket and battery housing are closed by a cover 9.

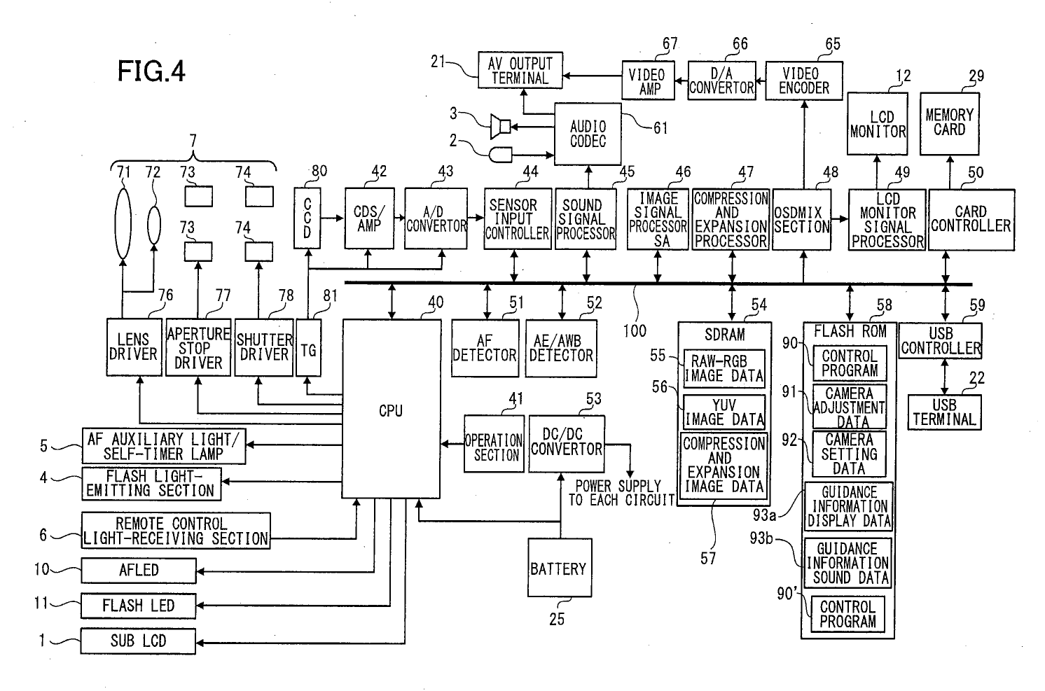

The side surface of the digital camera according to the embodiment includes an AV output terminal 21 (refer to FIG. 4) for connecting the digital camera to an external display device such as a TV, a USB terminal 22 (refer to FIG. 4) for connecting the digital camera to an external information terminal device such as a personal computer, and the like.

The flash light-emitting section 4 includes a light source for flash light emitting. The AF auxiliary light/self-timer lamp 5 includes an operation which projects auxiliary light to a subject in auto-focusing and a flashing operation in self-timer mode.

The remote control light-receiving section 6 includes an operation which receives an infrared light signal from a not illustrated remote control terminal device.

The constitutions and the operations of the lens barrel unit 7 and the front optical finder 8 will be described later as appropriate. A memory card 29 (refer to FIG. 4) as a recording medium is inserted in the memory card socket. A battery 25 is housed in the battery housing.

The back surface of the digital camera includes an AFLED 10 which lights in an AF operation, a flash LED 11 which lights in flash lighting, an LCD monitor 12, a back optical finder 13 and a power source switch 14.

The LCD monitor 12 is an image monitor which can display a color image. This LCD monitor 12 is used as an image display panel for displaying a photographed image in the playback mode. This LCD monitor 12 is used as a user interface display panel for various setting operations in the setup mode. This LCD monitor 12 displays a live view as appropriate in the photographing mode. Therefore, the LCD monitor 12 can be used as a finder for confirming an angle of view.

The back surface of the digital camera includes various switches such as a zoom (WIDE) switch SW3, zoom (TELE) switch SW4, up/flash switch SW5, right switch SW6, down/macro switch SW7, left/image confirmation switch SW8, self-timer/deletion switch SW9, menu switch SW10, OK switch SW11, display switch SW12, and quick access switch SW13.

The zoom (WIDE) switch SW3 and zoom (TELE) switch SW4 are used for the zooming operation of the digital camera. The digital camera performs the zooming operation to the wide-angle side in response to the operation of the zoom (WIDE) switch SW3 in the photographing mode.

The digital camera performs the zooming operation on the telephoto side in response to the operation of the zoom (TELE) switch SW4. The focal length of the lens is thereby changed.

In response to the operation of the zoom (WIDE) switch SW3 in the playback mode, a reduced image in playback is displayed on the LCD monitor 12.

An enlarged image in playback is displayed on the LCD monitor 12 in response to the operation of the zoom (TELE) switch SW4.

The up/flash switch SW5 is used for switching the flash mode (emission inhibition, auto, red-eye reduction, forced emission, slow synchronization) and moving up a cursor Ca on the LCD monitor 12.

The right switch SW6 is used for moving right the cursor Ca on the LCD monitor 12. The down/macro switch SW7 is used for moving down the cursor Ca on the LCD monitor in macro photographing. The left/image confirmation switch SW8 is used for confirming a photographed image on the LCD monitor 12 and moving left the cursor Ca on the LCD monitor 12.

The self-timer/deletion switch SW9 is used for operating the self-timer and deleting an image displayed on the LCD monitor 12. The menu switch SW10 is used for indicating a change from a normal screen of each mode to a menu screen. The OK switch SW11 is used for confirming a selection content and indicating execution of a process.

The display switch SW12 is used for switching display/non-display of a mark of the LCD monitor 12 and indicating a change in the display condition of the screen of the LCD monitor 12. The display content of the screen of the LCD monitor 12 is switched from histogram display→grid guide display→no mark display→LCD monitor OFF→normal mark display histogram display→ . . . at every operation of the display switch SW 12 in the photographing mode.

The display content of the screen of the LCD monitor 12 is switched from histogram display→highlight display→no mark display→normal mark display→histogram display→ . . . at every operation of the display switch SW12 in the playback mode. The display switch SW12 is used for a cancelling operation of an input operation and indicating returning to a previous operation state. The quick access switch SW13 is used for selecting a registered menu at once.

### (General Description of Circuit Constitution and Operation of Control System of Digital Camera)

FIG. 4 is a block diagram illustrating a circuit constitution of a control system of a digital camera. The entire operation of the digital camera is controlled by a CPU (central processing unit) 40.

The CPU 40 controls the entire digital camera in accordance with a predetermined control program 90 based on operation signals input from the switches SW1-SW13 and the output signal received from the remote control light-receiving portion 6. The switches SW1-SW13 are illustrated as the operation section 41 in FIG. 4.

The CPU 40 controls the photographing of an image by a digital camera, the playback of the photographed image and the like. The CPU 40 also controls the flash light-emitting from the flash light-emitting section 4, the lighting of the AF auxiliary light/self-timer lamp 5, AFLED 10 and flash LED 11, and the display of the sub LCD. The operation power source of the CPU 40 is supplied from a battery 25. The electric power from the battery 25 is supplied to each circuit inside the digital camera through a DC/DC convertor 53.

A flash ROM 58 is connected with the CPU 40 through a bus 100. This flash ROM 58 stores a control program which is performed by the CUP 40 and various setting information regarding the operations of the digital camera such as various data required for control, user setting information (for example, camera adjusting data 91 and camera setting data 92) and the like.

Guidance information simply expressing, for example, the description of various operations regarding the image photographing of the digital camera and an operation method for setting functions is stored in the flash ROM 58 as guidance information display data 93a and guidance information sound data 93b.

A SDRAM 54 is used as a range for the calculation operation of the CPU 40 and a temporary storing range for image data (Raw-RGB image data 55, YUV image data 56, compression and expansion image data 57) or the like.

The lens barrel unit 7 includes a zoom lens 71 and a focusing lens 72 for introducing light beams from a subject, a lens driver 76 for driving the lenses, an aperture stop 73, a driver 77 for controlling the aperture stop 73, a mechanical shutter 74 and a shutter driver 78 for driving the mechanical shutter 74.

The lens driver 76, aperture stop driver 77 and shutter driver 78 are controlled by the driving command from the CPU 40.

The control program stored in the flash ROM 58 is loaded in the SDRAM 54 upon the power-on of the digital camera. The CPU 40 controls the operation of each section of the digital camera according to the control program 90. The CPU 40 temporarily stores in the SDRAM 54, for example, data required for the control.

The flash ROM 58 is a rewritable half non-volatile memory. Therefore, in the digital camera, the control program 90, the various data required for the control, the user setting information (for example, camera adjusting data 91 and camera setting data 92) or the like can be changed. As a result, the functions of the digital camera can be easily upgraded.

In this digital camera, the guidance information display data 93a and guidance information sound data 93b regarding a new function are stored in the flash ROM 58 together with the upgrading of the functions, so that the guidance information corresponding to a new function can be provided.

If the photographing mode is selected by the operation of the mode dial SW2, the operation mode of the digital camera is set in the photographing mode.

Consequently, the digital camera can photograph a subject. If the mode dial SW2 is set to the photographing mode, the lens barrel unit 7 is extended from the camera body to be a photographing standby state.

In this photographing mode, the light beams from the subject which have passed through the lenses (zoom lens 71 and focusing lens 72) of the lens barrel unit 7 are imaged on a light-receiving surface of a CCD 80 as an imaging element (imaging section) through the aperture stop 73. In addition, another imaging element such as a CMOS image sensor can be used instead of the CCD 80.

Photodiodes (light-receiving element) as a lot of are two-dimensionally arranged in the light-receiving surface of the CCD 80. A color filter of red (R), green (G), blue (B) of a predetermined arrangement structure (for example, Bayer and G strip) is arranged on the front faces of the photodiodes (light-receiving element).

The light beams from the subject, which have passed through the lenses, are received by each photodiode through the color filter of the predetermined arrangement structure. Each photodiode converts the received subject light into a signal charge according to the received light volume.

The signal charge accumulated in each photodiode is sequentially read from the photodiode as a voltage signal (image signal) according to the signal charge by the driving pulse from a timing generator (TG) 81. The voltage signal is output toward an analogue processor (CDS/AMP) 42.

The analogue processor (CDS/AMP) 42 samples and holds (correlation double sampling process) the RGB signal of each input pixel and amplifies the signal, and outputs the amplified signal to an AD convertor 43.

The A/D convertor 43 converts the analogue RGB signal output from the analogue processor (CDS/AMP) 42 into the digital RGB signal.

The digital RGB signal output from the A/D convertor 43 is loaded in the SDRAM 54 as Raw-RGB image data 55 through a sensor input controller 44.

An image signal processor 46 processes the Raw-RGB image data 55 loaded in the SDRAM 54 according to the command of the CPU 40. Namely, the image signal processor 46 converts the data into a brightness signal (Y signal) and a color difference signal (Cr, Cb signal), and produces the YUV image data 56.

The image signal processor 46 operates as an image signal processor including, for example, a synchronization circuit (a process circuit which synchronously converts color signals by interpolating the spatial gap of the color signal according to the arrangement of the color filter of a single-panel CCD), a white balance correction circuit, a gamma correction circuit, a contour correction circuit, and a brightness and color difference signal generation circuit.

The image signal processor 46 processes the input RGB signal to generate the brightness and color difference signal (brightness/color difference signal) while using the SDRAM 54 as a work area according to the command from the CPU 40. The generated brightness/color difference signal is stored in the SDRAM 54 as the YUV image data 56.

The YUV image data 56 is sent to an OSDMIX section 48 from the SDRAM 54 when outputting the photographed image to the LCD monitor 12.

The OSDMIX section 48 overlaps on-screen display data such as characters or figures with the brightness/color difference signal of the input YUV image data 56, and outputs the synthesized data to a video encoder 65 and an LCD monitor signal processor 49.

Therefore, required photographing information is overlapped with the image data to be displayed.

If it is determined by the CPU 40 that the display of the guidance information is necessary and the guidance information display data 93a as a display target is read from the flash ROM 58 and input to the OSDMIX section 48, the OSDMIX section 48 synthesizes the guidance information display data 93a and the brightness/color difference signal of the YUV image data 56, and outputs the synthesized data to the LCD monitor signal processor 49.

The guidance information is thereby overlapped with the image data to be displayed on the LCD monitor 12.

The video encoder 65 converts the input brightness and color difference signal of the YUV image data 56 into the digital display output signal for displaying (for example, NTSC type color complex picture signal). The digital display output signal is input to a D/A convertor 66. The D/A convertor 66 converts the digital display output signal into the analogue video output signal.

A video AMP 67 converts the impedance of the analogue video output signal output from the D/A convertor 66 into 75Ω, and outputs the converted signal to the AV output terminal 21. The AV output terminal 21 is used for connecting an external display device such as a TV. The image obtained by the CCD 80 is displayed on the external display device such as a TV by the AV output terminal 21.

The LCD monitor signal processor 49 converts the input brightness/color difference signal of the YUV image data 56 into the RGB signal of the input signal format of the LCD monitor 12, and outputs the RGB signal to the LCD monitor 12. The image obtained by the CCD 80 is thereby displayed on the LCD monitor 12.

The image signal is regularly loaded from the CCD 80, and the YUV image data 56 in the SDRAM 54 is regularly written by the brightness/color difference signal generated by the image signal.

The regularly rewritten YUV image data 56 is output to the LCD monitor 12 and the AV output terminal 21, so that the image obtained by the CCD 80 is displayed in real time.

A user can check a photographing angle of view by viewing an image (live view) displayed on the LCD monitor 12 in real time.

The photographing of the subject is performed by the pressing of the shutter button SW1. Prior to the photographing, a user operates the zoom (WIDE) switch SW3 and the zoom (TELE) switch SW4 if the adjustment of an angle of view is required, and adjusts the angle of view by zooming the zoom lens 71.

In response to the half-pressing of the shutter button SW1, a release R1 on signal is input to the CPU 40. The CPU 40 thereby performs the AE/AF process.

At first, the image signal loaded from the CCD 80 through the sensor input controller 44 is input to an AF detector 51 and an AE/AWB detector 52.

The AE/AWB detector 52 includes a circuit which divides one screen into a plurality of areas (for example, 16×16), and integrates R, G, B signals with respect to each divided area. The AE/AWB detector 52 provides the integrated value obtained by the circuit to the CPU 40.

The CPU 40 calculates an exposure value (photographing EV value) suitable for photographing by detecting the brightness of a subject (subject brightness) based on the integrated value obtained from the AE/AWE detector 52.

The CPU 40 determines an aperture stop value and a shutter speed from the obtained photographing EV value and a predetermined program line. The CPU 40 controls the electric shutter of the CCD 80 and the aperture stop driver 77, so that the appropriate exposure amount is obtained.

The AE/AWB detector 52 calculates an average integrated value of each color of the RGB signal with respect to each divided area in the automatic white balance adjustment. The AE/AWB detector 52 provides the calculated result to the CPU 40. The CPU 40 obtains the ratio of R/G and the ratio of B/G with respect to each divided area from the obtained R integrated value, B integrated value, and G integrated value. The CPU 40 determines the light source type based on the distribution or the like in the color spaces of R/G and B/G of the obtained R/G and B/G values.

The CPU 40 corrects the signal of each color channel according to the white balance adjustment value suitable for the determined light source type.

The CPU 40 controls the gain value (white balance correction value) relative to the RGB signals of the white balance adjustment circuit such that the value of each ratio becomes 1, for example, (namely, the integrated ratio of RGB in one screen becomes R:G:B≈1:1:1), and corrects the signal of each color channel.

The AF detector 51 includes a high pass filter which passes through only a high frequency component of G signal, an absolute value processor, an AF area extractor which clips a signal in a predetermined focusing area (for example, central portion of screen), and an integrating section which integrates absolute value data in the AF area.

The integrated value obtained in the AF detector 51 is informed to the CPU 40. The CPU 40 calculates a focal point evaluation value (AF evaluation value) at a plurality of AF detection points while moving the focusing lens 72 by controlling the lens driver 76, and determines a lens position where the evaluation value becomes the maximum as a focused position. The CPU 40 controls the lens driver 76 such that the focusing lens 72 is moved to the obtained focused position.

As described above, the AE/AF process is performed in response to the half-pressing of the shutter button SW1. After that, if a user fully presses the shutter button SW1, the R2 on signal is input to the CPU 40, and the CPU 40 starts the photographing and recording process of the image.

Namely, the CPU 40 drives the aperture stop 73 by controlling the aperture stop driver 77 according to the aperture stop value determined by the light measurement result. The CPU 40 controls the opening and closing operation of the mechanical shutter 74 by controlling the shutter driver 78 according to the shutter speed value. The exposure time of the CCD 80 is thereby controlled, and the CCD 80 is exposed according to the set exposure time.

The image signal output from the CCD 80 is loaded into the SDRAM 54 through the analogue processor (CDS/AMP) 42, A/D convertor 43, and sensor input controller 44. The image signal is stored in the SDRAM 54 as the YUV image data after being converted into the brightness/color difference signal in the image signal processor 46.

After the YUV image data 56 stored in the SDRAM 54 is transferred to the compression and expansion processor 47 to be compressed according to a predetermined compression format (for example, JPEG format), the compressed YUV image data is stored in the SDRAM 54 as the compression and expansion image data 57. The YUV image data is converted into an image file of a predetermined image recording format (for example, Exif format) when being stored in the SDRAM 54, and is recorded in the memory card 29 (for example, SD card) through the card controller 50.

The compressed image data recorded in the memory card 29 as described above is displayed on the LCD monitor 12 if the playback mode is selected by the operation of the mode dial SW2, and the operation mode of the digital camera is set to the playback mode.

Namely, if the operation mode of the digital camera is set to the playback mode, the CPU 40 outputs a command to the card controller 50. The image file finally recorded in the memory card 29 is thereby read.

After the compressed image data of the read image file is transferred to the compression and expansion processor 47, and expanded into the non-compressed brightness/color difference signal, the image data is output to the LCD monitor 12 through the OSDMIX section 48 and the LCD monitor signal processor 49.

The image recorded in the memory card 29 is thereby displayed on the LCD monitor 12.

In the case of the USB communication with an external information terminal device such as a personal computer, the digital camera is connected with the external information terminal device through the USB terminal 22. The CPU 40 controls the USB controller 59, so that the USB communication with the external information terminal device is conducted.

The sound signal data such as shutter sound and operation sound is stored in the flash ROM 58. The CPU 40 controls the sound signal processor 45. This sound signal data is output to an audio CODEC 61 through the sound signal processor 45.

If it is determined that the sound output of the guidance information is necessary, the CPU 40 reads the guidance information sound data 93b as a sound output target from the flash ROM 58. The guidance information sound data 93b is output to the audio CODEC 61 through the sound signal processor 45.

The audio CODEC 61 incorporates a microphone amplifier which amplifies the input sound signal and an audio amplifier which drives the speaker 3. The microphone 2 with which a user inputs a sound signal (refer to FIG. 1) and the speaker 3 which outputs the sound signal are connected with the audio CODEC 61.

The audio CODEC 61 drives the speaker 3 with the audio amplifier according to the sound signal data and guidance information sound data 93b input from the sound signal processor 45. The shutter and operation sounds and the guidance information are output from the speaker 3.

### (Detailed Description of Digital Camera)

This digital camera includes a snap moving image-photographing function. A control program 90′ which performs the snap moving image photographing is stored in the flash ROM 58.

In the moving image photographing mode, the CPU 40 controls the memory card 29 such that an attention point moving image for a time designated by an attention point moving image time designation section is stored in the memory card 29 at every designation of an attention point moving image designation section during the photographing in the snap moving image mode by the operation of the shutter button SW1.

The shutter button SW1 operates as an operation section which designates the start and stop of the recording of the moving image data to the recorder in the moving image mode.

The memory card 29 operates as a recording section which can record the image data from the image processor 46 as the moving image data during the photographing in the moving image mode.

The attention point moving image designation section includes a function which designates an attention point moving image as a set of moving images which are desired to be stored by being clipped from the moving image obtained by the moving image photographing during the photographing in the moving image mode. The attention point moving image time designation section includes a function which designates the clipping time of the attention point moving image from the start to the end.

The details of the attention point moving image designation section and the attention point moving image time designation section will be described while describing a process in the snap moving image photographing as described below.

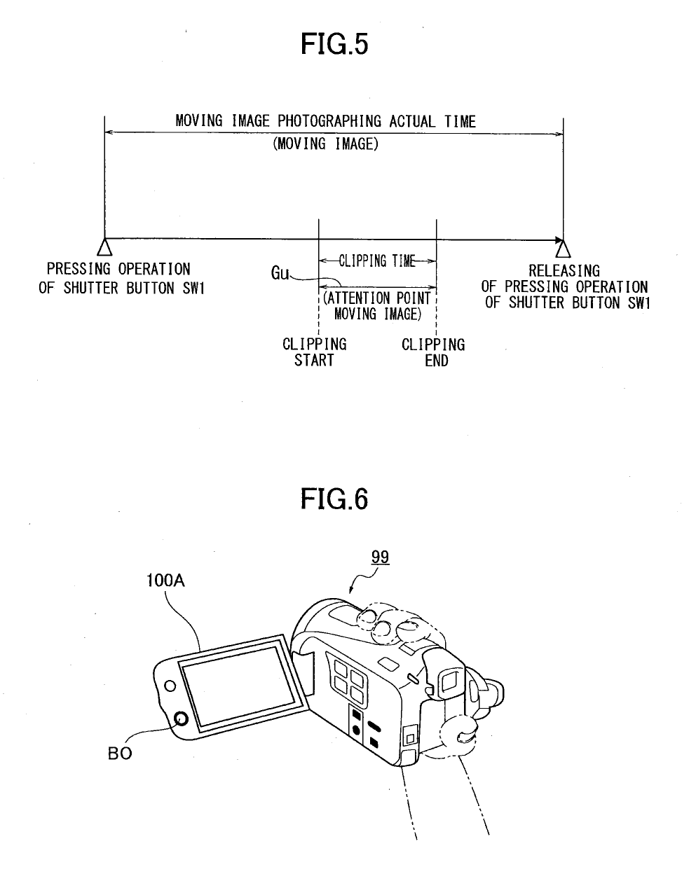

A set of moving images, which are desired to be stored by being clipped from the moving image obtained by the moving image photographing by operating the attention point moving image designation section during the photographing in the moving image mode, is an attention point moving image. FIG. 5 illustrates an actual time of photographing in the moving image mode. Reference GU illustrates the attention point moving image as a set of moving images which are desired to be stored by being clipped during the photographing of the moving image.

### (Designation of Attention Point Moving Image GU)

A switch different from the shutter button SW1 is used for designating the attention point moving image GU. For example, the self-timer/deletion switch SW9 (refer to FIG. 3) provided in the back surface of the digital camera can be used for the designation. It is preferable for the switch for use in the designation of the attention point moving image GU to be provided in a position where camerawork is not disturbed even if the switch is operated in the moving image photographing.

For example, a button BO is provided on the left end side of a liquid crystal screen 100A in a video camera 99 as illustrated in FIG. 6. The attention point moving image GU is designated by picking the lower left side of the liquid crystal screen 100A with the left hand while holding the main body of the video camera with the right hand as illustrated in FIG. 6, so that the attention point moving image GU can be designated while photographing the moving image with the stabilized camera.

The button BO operates as the attention point moving image designation section in the video camera 99, illustrated in FIG. 6. For example, the self-timer/deletion switch SW9 operates as the attention point moving image designation section in the digital camera illustrated in FIGS. 1-3.

If the attention point moving image GU is designated by using the self-timer/deletion switch SW9, the self-timer/deletion switch SW9 fulfills the attention point moving image designation function which designates the attention point moving image GU only in the photographing in the moving image mode. Namely, when the photographing in the moving image mode is not performed, the control program 90′ is produced to fulfill the normal function as the self-timer/deletion switch SW9.

The attention point moving image GU can be designated as many times as desired during the photographing in the moving image mode. If the attention point moving image data GU is designated by pressing the self-timer/deletion switch SW9, a message which means that the attention point moving image GU is designated is displayed on the screen of the LCD monitor 12 as illustrated in FIG. 3, so that a user can confirm the attention point moving image GU.

In the above example, the attention point moving image GU is designated by using the self-timer/deletion switch SW9, which is different from the shutter button SW1, as the start and stop switch of the photographing in the moving image mode.

However, in a touch-screen LCD monitor, the attention point moving image GU can be designated by a tapping operation. Moreover, in a digital camera having a not shown infrared light remote control receiving section, the attention point moving image GU is designated every time by using the infrared signal of the remote control terminal device.

### (Example for Designating Attention Point Moving Image GU by Touch-Screen Liquid Crystal Display Device)

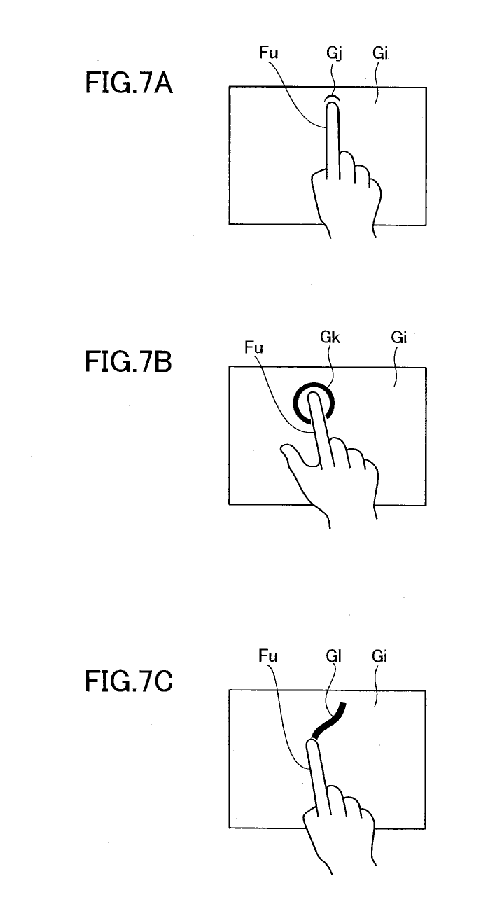

FIGS. 7A-7C illustrate an example for designating the attention point moving image GU by a touch-screen liquid crystal display device. FIG. 7A illustrates the designation of the attention point moving image GU by a tapping operation. FIG. 7B illustrates the designation of the attention point moving image GU by pressing and holding. FIG. 7C illustrates the designation of the attention point moving image GU by dragging.

The tapping operation is an operation which taps a screen Gi of the LCD monitor by a finger Fu as illustrated in FIG. 7A. Reference number Gj schematically illustrates a portion on the screen Gi of the monitor concaved by the tapping operation. The tapping operation corresponds to the clicking of a mouse.

The pressing and holding operation means a condition which maintains an operation for pressing an appropriate position on the screen Gi of the LCD monitor by the finger Fu for a limited time. Reference number Gk schematically illustrates a portion on the screen Gi of the monitor concaved by the pressing and holding operation. This pressing and holding operation corresponds to the right-clicking of a mouse.

The dragging operation means an operation which shifts the finger Fu on the screen Gi while pressing the screen Gi of the LDC monitor by the finger Fu. Reference number G1 illustrates a trajectory on the screen Gi of the monitor by the dragging operation.

The screen Gi of the monitor operates as the attention point moving image designation section in this touch-screen liquid crystal display device.

Hereinafter, the procedure for setting the snap moving image from the moving image data and the procedure for setting the clipping time of the attention point moving image GU and the clipping start position will be described.

In this embodiment, the clipping time and the clipping start position of the attention point moving image GU are set on the menu screen of the setup mode.

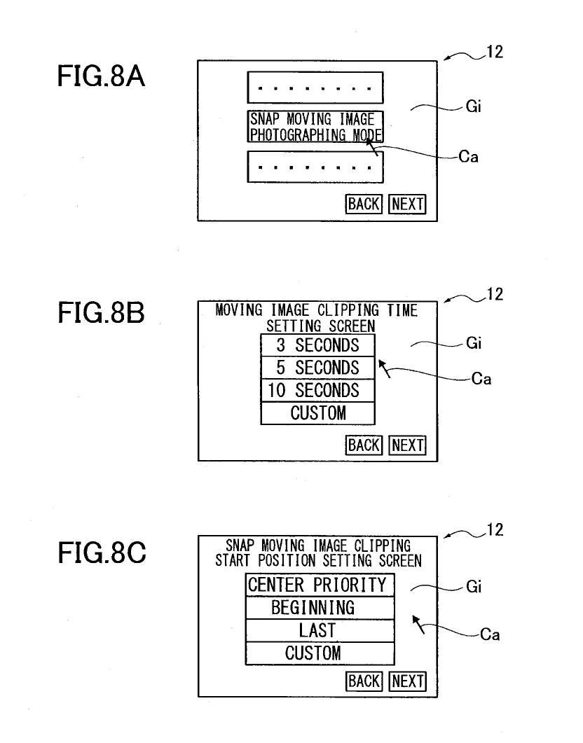

If the setup mode is selected by operating the mode dial SW2 illustrated in FIG. 2, the screen Gi of the LCD monitor 12 becomes a menu screen, and various menus including the snap moving image-photographing mode setting is displayed as illustrated in FIG. 8A.

The cursor Ca is located in the item of “SNAP MOVING IMAGE PHOTOGRAPHING MODE” by operating the up/flash switch SW5, right switch SW6, down/macro switch SW7, left/image confirmation switch SW8, and the setting is confirmed by operating the OK switch SW11.

Next, the cursor Ca is located in “NEXT” by operating the respective switches SW5-SW8, and the setting is confirmed by operating the OK switch SW11. Then, the screen Gi of the LCD monitor 12 is changed to the moving image clipping time setting screen illustrated in FIG. 8B from the menu screen.

Four types of 3 seconds, 5 seconds, 10 seconds and custom are displayed as the setting values of the snap moving image photographing time on the moving image clipping time setting screen. In this embodiment, the menu screen of the LCD monitor 12 operates as the attention point moving image time designation section which designates the clipping time of the attention point moving image.

If the cursor Ca is set to “3 SECONDS” by operating the respective switches SW5-SW8, a moving image for 3 seconds in the actual photographing time is clipped. Similarly, if the cursor Ca is set to “5 SECONDS”, a moving image for 5 seconds in the actual photographing time is clipped. If the cursor Ca is set to “10 SECONDS”, a moving image for 10 seconds in the actual photographing time is clipped. If the cursor Ca is set to “CUSTOM”, the clipping time of the moving image can be set by a second.

Next, the cursor Ca is located in “NEXT” by operating the respective switches SW5-SW8, and the setting is confirmed by operating the OK switch SW 11. Then, the screen Gi of the LCD monitor 12 is changed to the snap moving image clipping start position setting screen illustrated in FIG. 8C from the moving image clipping time setting screen.

One type can be set from the four types of “CENTER PRIORITY”, “BEGINNING”, “LAST” and “CUSTOM” on the snap moving image clipping time start position setting screen.

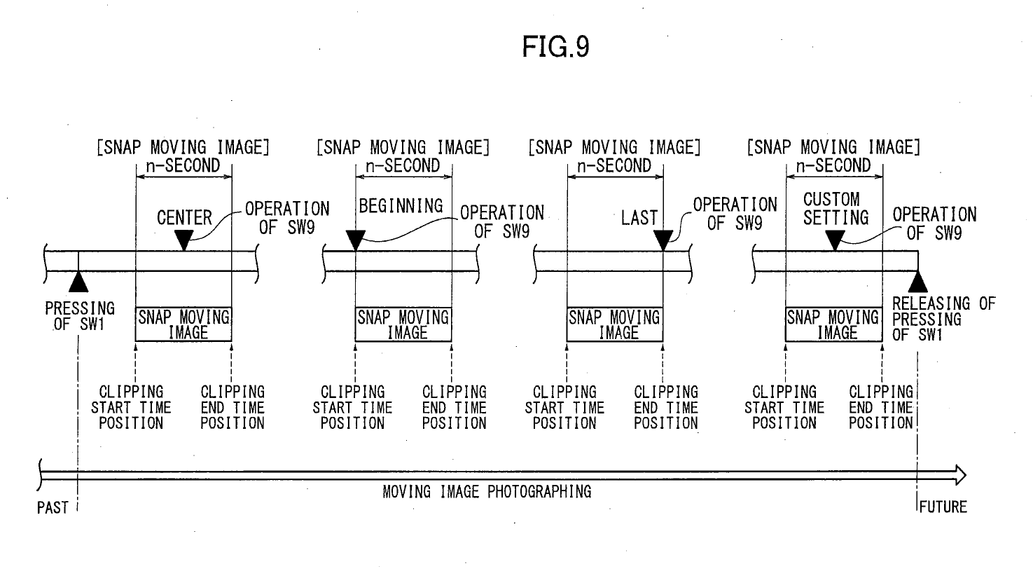

“CENTER PRIORITY” means to clip the moving image for the snap moving image clipping time by setting the time position of (−[snap moving image time]/2)-second back in the past as the clipping start time position and by setting the passage time position of (+[snap moving image time]/2)-second in the future direction as the clipping end time position with the central value of the clipping time of the moving image as a standard as illustrated in FIG. 9

Namely, a time when the self-timer/deletion switch SW9 is operated is set as the center value of the moving image clipping time, the time position of (−[snap moving image time]/2)-second, which is the front of the center value, is set as the clipping start time position, and the time position of (+[snap moving image time]/2)-second, which is the back of the center value, is set as the clipping end time position if the self-timer/deletion switch SW9 is used as the attention point moving image designation section.

“BEGINNING” means to clip the moving image for the snap moving image time by setting the beginning time position of the moving image clipping time as the clipping start time position and by setting the passage time position of (+[snap moving image time])-second in the future direction as the clipping end time position with the clipping start time position as a standard, as illustrated in FIG. 9. Namely, a time when the self-timer/deletion switch SW9 is operated is set to the clipping start time position, and the time position after the clipping start time is set to the clipping end time position.

“END” means to clip the moving image for the snap moving image time by setting the end of the moving image clipping time as the clipping end time position and the time position of the (−[snap moving image time])-second back to the past as the clipping start position with the clipping end time position as a standard, as illustrated in FIG. 9.

Namely, a time when the self-timer/deletion switch SW9 is operated is set to the clipping end time position and the time position of (−[snap moving image time])-second back to the past is set to the clipping start time position.

“CUSTOM SETTING” means to set the clipping start time position by a second with a time set from 1 second to the snap moving image photographing time as the maximum value.

In addition, the clipping start time position can be set as many times as desired in the moving image photographing in “CUSTOM SETTING”. It is desirable for a user to confirm the setting of the attention point moving image GU by displaying a message on the screen of the LCD monitor 12. Reference number n denotes the snap moving image photographing time (attention point moving image).

In these examples, the snap moving image photographing time is set on the menu screen of the setup mode. The following can be used instead of the menu screen of the setup mode in the touch-screen LCD monitor.

For example, the clipping start time position of the snap moving image as the attention point moving image can be designated by the pressing and holding operation which does not release a finger from the screen of the LCD monitor after touching the screen of the LCD monitor, and the moving image data for a period in which the pressing and holding operation is maintained can be clipped.

Instead of the pressing and holding operation, the moving image in a period in which the self-timer/deletion switch SW9 is pressed can be clipped.

In this embodiment, the snap moving image mode is set by using the menu screen, but it is difficult to set a menu because a user's photographing intention always changes according to a subject condition.

In this case, the following constitution can be adopted.

For example, the clipping start time position with “CENTER PRIORITY” is set by the short-pressing of the self-timer/deletion switch SW9, and the beginning position can be set to the clipping start time position by the long-pressing of the self-timer/deletion switch SW9. In the touch-screen LCD monitor, the clipping start time position with “CENTER PRIORITY” can be set by single tapping and the beginning position can be set to the clipping start time position by double tapping.

### (General Description of Snap Moving Image Photographing)

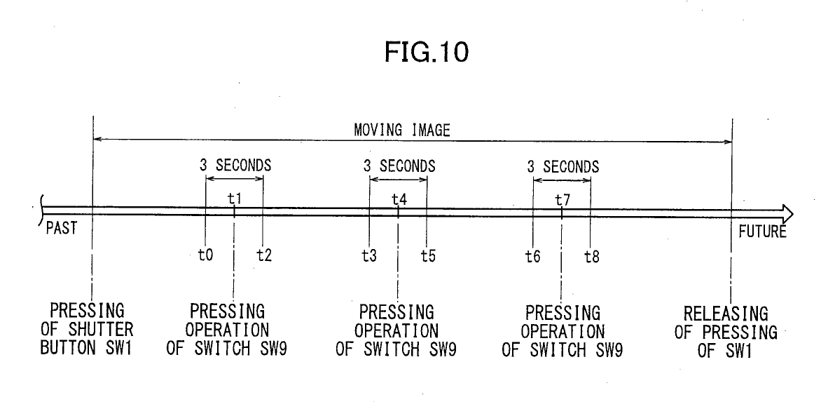

The general description of the snap moving image photographing will be described next with reference to FIG. 10. In FIG. 10, the time flows from the past on the left side to the future on the right side. The moving image clipping time is set to “3 SECONDS”, and the clipping start time position is set with “CENTER PRIORITY”. Upon the pressing operation of the shutter button SW1, the actual time moving image photographing is performed. This moving image photographing is continued until the pressing operation of the shutter button SW1 is released.

If the self-timer/deletion switch SW9 is operated at the time t1 to indicate the snap moving image photographing, the time t0, which is 1.5 seconds prior to the time t1, is set to the clipping start time position, so that the moving image data from time t0 to the time t2 after 3 seconds is clipped, and the clipped moving image data is recorded in the memory card 29 by the CPU 40.

Moreover, if the self-timer/deletion switch SW9 is operated at the arbitrary time t4 after a predetermined time from the time t1 to indicate the snap moving image photographing, the time t3, which is 1.5 seconds prior to the time t4, is set to the clipping start time position, so that the moving image data from the time t3 to the time t5 after 3 seconds is clipped, and the clipped moving image data is recorded in the memory card 29 by the CPU 40.

Next, upon the indication of the snap moving image photographing at the arbitrary time t7, the time t6, which is 1.5 seconds prior to the time t7, is set to the clipping start time position, so that the moving image data from the time t6 to the time t8 after 3 seconds is clipped, and the clipped moving image is recorded in the memory card 29 by the CPU 40.

As described above, a set of the clipped moving image data is stored in the memory card 29 as a moving image file.

According to the clipping of the snap moving image with “CENTER PRIORITY”, the moving image including scenes before and after the most interesting scene can be clipped.

The clipping of the snap moving image with “BEGINNING” is effective for a case in which a user's expected scene is anticipated a little after the clipping start time.

According to the clipping of the snap moving image with “LAST”, a moving image expected by a user can be clipped even if the operation of the self-timer/deletion switch SW9 is delayed by a user.

In addition, original long moving image data can be recorded in the memory card 29 as a moving image file, or the original long moving image data can be disposed of.

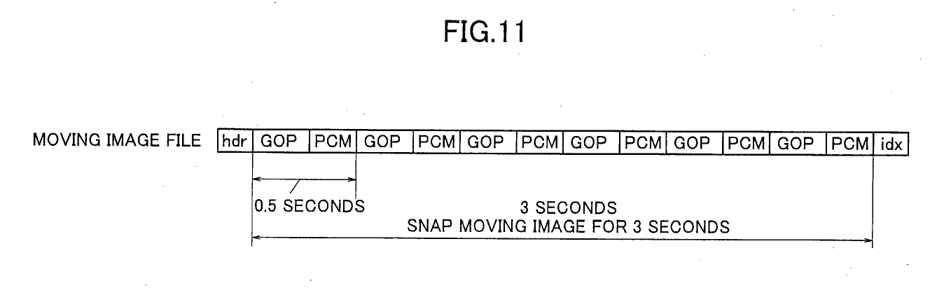

The moving image file is coded by a unit which is referred to as GOP in the MPEG method as illustrated in FIG. 11. In this case, GOP (Group of Pictures) is the minimum unit structure constituting a moving image defined in the MPEG standard. This embodiment is described according to GOP, but another moving image compressing and coding format such as MPEG-4, AVC or H. 264 can be used.

In FIG. 11, “hdr” indicates a header of image data, and “PCM” indicates pulse coding modulation which modulates an analogue signal such as sound to a pulse train, and “idx” indicates the end of the moving image data.

According to the MPEG method, GOP is set to a divisible value such as 0.5 seconds, and a dividing point is determined in the border of GOP in order to enable the snap moving image photographing even in the playback of the moving image.

As described above, once GOP is determined, the original moving image data and sound data are decoded, and the moving image can be clipped without re-coding. In this embodiment, the unit which divides the moving image is set to 0.5 seconds. For this reason, if the snap moving image is set to 3 second, the moving image file is constituted by 6 GOPs as illustrated in FIG. 11.

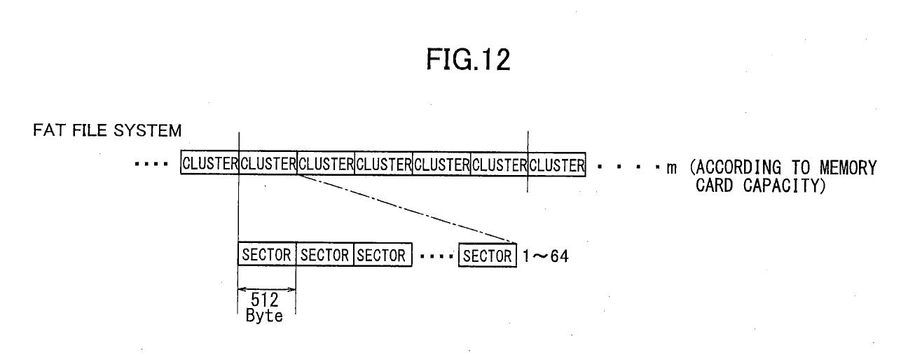

Respective electronic devices such as a digital camera or video camera use the FAT file system, as illustrated in FIG. 12. A recording medium is written by a block unit referred to as a sector. This sector has a standard size of 512 Bytes according to the tradition from MS-DOS. In addition, cluster, GOP and PCM include thereamong a certain corresponding relationship.

An actual file is read and written by the cluster in which the sectors are further collected. One cluster includes a plurality of sectors (1-64). Therefore, as is generally known, even if it is a 1-byte file, the capacity for 1 cluster is occupied in the recording medium.

A table which manages the relationship between the file and cluster and indicates that the data of the file is disposed is referred to as FAT (File Allocation Table). One file can be disposed in the continuous clusters, or can be disposed in discrete clusters.

When recording a moving image file in a recording section as a recording medium (for example, memory card 29), if the moving image file is recorded such that the unit for dividing a moving image conforms to the cluster border, a copying process when dividing a moving image becomes unnecessary and it can be read by the cluster when clipping a moving image. Consequently, the moving image can be divided and clipped at high speed.

In the above embodiment, the attention point moving image GU is designated while photographing a moving image, but the attention point can be designated during the playback of the moving image.

For example, a clipping start time position designation section which designates the clipping start time position of the attention point moving image during the playback of the moving image data in the playback mode can be provided, and the CPU 40 can be configured to control the memory card 29 such that the attention point moving image for the clipping time is clipped from the clipping start time position designated by the clipping start time position designation section, and is stored in the memory card 29 at every operation of the clipping start time position designation section during the playback of the moving image data.

According to the embodiment of the present invention, the attention point moving image can be designated during long real-time photographing in the moving image mode, and the attention point moving image can be clipped, so that a short video picture which is desired to be stored can be obtained. With this constitution, a good video picture in which a user's photographing intention is reflected in the photographing can be simply obtained while performing the photographing without missing a photographing change.

Although the embodiment of the present invention has been described above, the present invention is not limited thereto. It should be appreciated that variations may be made in the embodiment described by persons skilled in the art without departing from the scope of the present invention.

What is claimed is:

1. An imaging device, comprising
an imaging section configured to receive a light beam from a subject, and output an image signal by photoelectrically converting the received light beam;
an image processor configured to produce image data based on the image signals input from the imaging section;
a recording section configured to record the image data from the image processor as moving image data during photographing in a moving image mode;
an operation section configured to designate start and stop of recording of the moving image data to the recording section;
an attention point moving image designation section configured to designate an attention point moving image as a set of moving images which are stored by being clipped from a moving image obtained by moving image photographing during the photographing in the moving image mode;
an attention point moving image time designation section configured to designate a clipping time of the attention point moving image; and
a controller configured to control the recording section such that the attention point moving image for the clipping time designated by the attention point moving image time designation section is recorded in the recording section at every designation of the attention point moving image designation section during the photographing in the moving image mode by the operation of the operation section.

2. The imaging device according to claim 1, wherein the controller sets a clipping start time position of the attention point moving image with a time designated by the attention point moving image time designation section as a center position of the clipping time.

3. The imaging device according to claim 1, wherein the controller sets a clipping start time position of the attention point moving image with a time designated by the attention point moving image time designation section as a beginning position of the clipping time.

4. The imaging device according to claim 1, wherein the controller sets a clipping start time position of the attention point moving image with a time designated by the attention point moving image time designation section as an end position of the clipping time.

5. The imaging device according to claim 1, wherein the operation section is a shutter button, and the attention point moving image designation section is one of respective switches constituting the operation section except for the shutter button.

6. The imaging device according to claim 1, wherein the operation section is a shutter button, and the attention point moving image designation section is a touch-screen monitor.

7. The imaging device according to claim 1, wherein the attention point moving image time designation section is provided in a setup menu screen of a monitor of a liquid crystal display device.

8. The imaging device according to claim 1 further comprising a clipping start time position designation section configured to designate a clipping start time position of the attention point moving image during playback of the moving image data in a playback mode, wherein
the controller controls the recording section such that the attention point moving image for the clipping time is clipped from the clipping start time position designated by the clipping start time position designation section, and is recorded in the recording section at every operation of the clipping start time position designation section during the playback of the moving image data.
